(19) United States
(12) Patent Application Publication
(10) Pub. No.: US 2009/0218287 A1
(43) Pub. Date: Sep. 3, 2009

(54) Solid phase extraction apparatuses and methods

(75) Inventors: Michael A. Vail, Genola, UT (US); Matthew R. Linford, Orem, UT (US)

Correspondence Address: HOLLAND & HART LLP, P.O. Box 11583, 60 E. South Temple, Suite 2000, Salt Lake City, UT, 84110, US

(73) Assignee: US Synthetic Corporation, Orem, UT (US)

(21) Appl. No.: 12/074,398

(22) Filed: Mar. 3, 2008

(51) Int. Cl. B01D 15/08

(52) U.S. Cl. 210/659; 210/198.2

(57) ABSTRACT

Embodiments of the present invention relate to solid phase extraction (“SPE”) apparatuses that include a sintered polycrystalline diamond (“PCD”) stationary phase and methods of performing SPE using a sintered PCD stationary phase. In one embodiment, an SPE cartridge includes a housing that comprises a proximal first end including a housing inlet, a distal second end including a housing outlet, and an interior space extending between the housing inlet and the housing outlet. An SPE stationary phase may be positioned within the interior space and includes an inlet and an outlet. The SPE stationary phase comprises a mass of sintered diamond grains including a plurality of passageways extending therethrough between the inlet and the outlet. In other embodiments, an SPE apparatus may employ a sintered PCD stationary phase in the form of a disk. In yet another embodiment of the present invention, an SPE stationary phase of an SPE apparatus may comprise un-sintered diamond particles.

### PARTIES TO A JOINT RESEARCH AGREEMENT

US Synthetic Corporation and Brigham Young University are parties to a joint research agreement.

### BACKGROUND

Solid phase extraction (“SPE”) is a well-known technique for concentrating and/or purifying a liquid sample for analysis. Many conventional SPE apparatuses include a syringe or syringe-like body in which a stationary phase is disposed. Using positive pressure from a plunger or application of a vacuum, a liquid sample can be passed through the stationary phase. The stationary phase selectively adsorbs at least one type of analyte of the liquid sample as the liquid sample is passed through the stationary phase. The at least one type of analyte is typically extracted by washing the stationary phase with a solvent having an affinity for the adsorbed at least one type of analyte and collecting the solvent including the at least one type of analyte. Chemical analysis may then be performed on the collected solvent and analyte using, for example, chromatography or another analytical technique.

The stationary phase is typically composed of silica particles having selected functional groups bonded to surfaces of the silica particles that are formulated to bond with specific analytes. Chemical stability of the stationary phase is a concern because the liquid samples and/or solvents used in SPE processes can chemically interact with the stationary phase. In addition to possibly degrading the stationary phase, such chemical interaction can reduce the accuracy of any subsequent chemical analysis performed on the isolated analyte. Despite the availability of many different types of stationary phases, manufacturers and users of SPE apparatuses continue to seek improved stationary phases suitable for SPE that are more chemically resistant to aggressive liquid samples and/or solvents commonly used in SPE processes.

### SUMMARY

Embodiments of the present invention relate to SPE apparatuses that include a sintered polycrystalline diamond (“PCD”) stationary phase and methods of performing SPE using a sintered PCD stationary phase. In one embodiment of the present invention, a method of capturing at least one constituent from a liquid sample is disclosed. A liquid sample may be flowed through an SPE stationary phase that comprises sintered diamond grains. At least a portion of the at least one constituent of the liquid sample may be captured in the SPE stationary phase as the liquid sample flows through the SPE stationary phase. In certain embodiments of the present invention, the at least one constituent (e.g., one or more types of analytes) captured in the SPE stationary phase may be eluted from the stationary phase.

In another embodiment of the present invention, an SPE cartridge includes a housing that comprises a proximal first end including a housing inlet, a distal second end including a housing outlet, and an interior space extending between the housing inlet and the housing outlet. An SPE stationary phase may be positioned within the interior space and includes an inlet and an outlet. The SPE stationary phase comprises a mass of sintered diamond grains including a plurality of passageways extending therethrough between the inlet and the outlet. In an embodiment of the present invention, the housing inlet may exhibit a lateral dimension that is greater than that of a lateral dimension of the housing outlet. In another embodiment of the present invention, the diamond grains of the SPE stationary phase include interior diamond grains surfaces that define the passageways, with at least some of the interior diamond grains surfaces being etched.

In yet another embodiment of the present invention, an SPE apparatus comprises an SPE stationary phase disk including an inlet face and an opposing outlet face. The SPE stationary phase disk comprises a mass of sintered diamond grains including a plurality of passageways extending therethrough between the inlet face and the outlet face. The SPE apparatus further comprises a holder configured to hold at least the SPE stationary phase disk so that a fluid can pass through the SPE stationary phase disk. The SPE apparatus also may include a container configured to be in fluid communication with the outlet face of the SPE stationary phase disk.

In other embodiments of the present invention, an SPE stationary phase of an SPE apparatus may comprise un-sintered diamond particles. For example, in one embodiment, an SPE stationary phase of an SPE apparatus may be in form of a mass of un-sintered diamond particles with exterior surfaces of the diamond particles being etched to increase the surface area thereof.

### BRIEF DESCRIPTION OF THE DRAWINGS

The drawings illustrate several embodiments of the present invention, wherein identical reference numerals refer to identical elements or features in different views or embodiments shown in the drawings.

FIG. 1A is a cross-sectional view of an SPE apparatus including a PCD stationary phase according to one embodiment of the present invention.

FIG. 1B is a cross-sectional view of the SPE apparatus shown in FIG. 1A including a filter positioned adjacent to an inlet of the PCD stationary phase and a seal element extending peripherally about the PCD stationary phase according to another embodiment of the present invention.

FIG. 2A is a perspective view of the PCD stationary phase shown in FIG. 1.

FIG. 2B is top plan view of the PCD stationary phase shown in FIG. 2A.

FIG. 2C is a cross-sectional view of the PCD stationary phase shown in FIG. 2A taken along line 2C-2C.

FIG. 3A is a schematic cross-sectional view that illustrates passing a liquid sample through the PCD stationary phase shown in FIG. 1 using a plunger so that one or more constituents of the liquid sample may be captured by the PCD stationary phase according to one embodiment of the present invention.

FIG. 3B is a schematic cross-sectional view that illustrates passing an eluting solution through the PCD stationary phase shown in FIG. 1 using a plunger to elute the one or more constituents captured by the PCD stationary phase according to one embodiment of the present invention.

FIG. 4 is a schematic cross-sectional view that illustrates drawing an eluting solution through the PCD stationary phase shown in FIG. 1 using a vacuum pump to elute the one or more constituents captured by the PCD stationary phase according to one embodiment of the present invention.

FIG. 5 is a partial, exploded perspective view of an SPE apparatus according to yet another embodiment of the present invention.

FIG. 6 is a side elevation view showing the SPE apparatus of FIG. 5 assembled.

### DETAILED DESCRIPTION

Embodiments of the present invention relate to SPE apparatuses that include a sintered PCD stationary phase and methods of performing SPE to capture at least one constituent of a liquid sample using a sintered diamond stationary phase. The disclosed SPE apparatuses may be used for concentrating and/or purifying a liquid sample prior to performing chemical analysis, such as chromatography, mass spectrometry, or another suitable analytical technique.

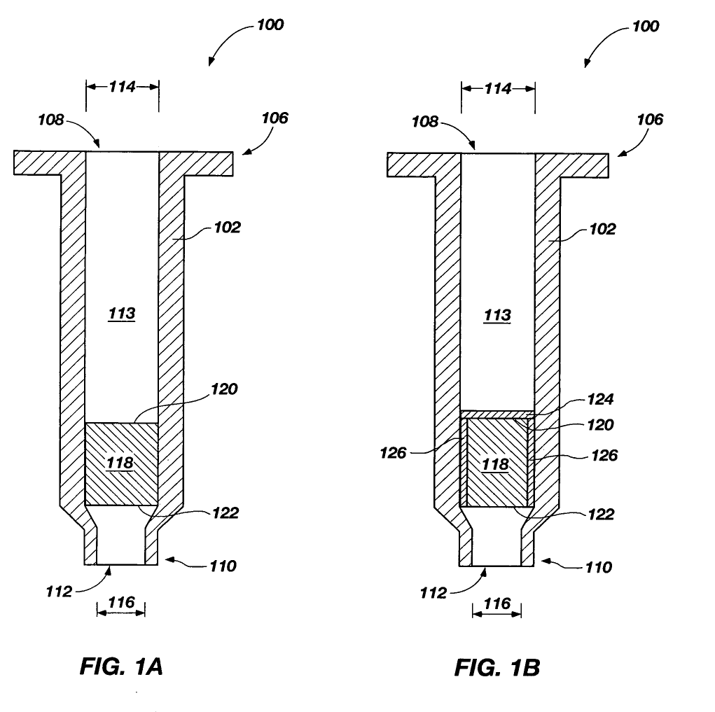

FIG. 1A is a cross-sectional view of an SPE apparatus/cartridge 100 configured to concentrate and/or purify a liquid sample according to one embodiment of the present invention. The SPE cartridge 100 comprises a housing 102 including a proximal first end 106 having a housing inlet 108 and a distal second end 110 having a housing outlet 112. An interior space 113 defined by the housing 102 extends between the housing inlet 108 and the housing outlet 112, and the interior space 113 is also in communication with the housing inlet 108 and the housing outlet 112. In the illustrated embodiment, the housing inlet 108 may exhibit a lateral dimension 114 (e.g., a diameter) that is greater than that of a lateral dimension 116 (e.g., a diameter) exhibited by the housing outlet 112. However, in other embodiments, the lateral dimension 114 of the housing inlet 108 may be equal to or less than the lateral dimension 116 of the housing outlet 112. The housing 102 may be formed from a polymeric material (e.g., polypropylene), a ceramic (e.g., a glass or other inorganic material), or another suitable material.

Still referring to FIG. 1A, a PCD stationary phase 118 may be positioned within the interior space 113. The PCD stationary phase 118 includes an inlet 120 and an outlet 122 through which a liquid (e.g., a liquid sample or an eluting solution) may flow between. In the illustrated embodiment, the PCD stationary phase 118 is depicted as a cylindrical body. However, the PCD stationary phase 118 may exhibit any suitable geometry, without limitation, such as a disk-shaped geometry. A frit or filter (not shown) may be positioned adjacent to the outlet 122 to help retain the stationary phase 118 in the housing 102, if desired. Referring to FIG. 1B, in certain embodiments of the present invention, a filter 124 may be positioned adjacent to the inlet 120 of the PCD stationary phase 118 to help prevent any particulate matter contained in a liquid sample from clogging the PCD stationary phase 118. Additionally, a seal member 126 may extend peripherally about the PCD stationary phase 118 to form a seal between the PCD stationary phase 118 and an interior of the housing 102 to help prevent a liquid sample from flowing between the interior of the housing 102 and the PCD stationary phase 118. The seal member 126 may comprise a polymeric material (e.g., a heat-shrink polymeric sleeve), a curable material, a metallic material, or any material capable of inhibiting flow of fluid between the housing 102 and the PCD stationary phase 118. The housing 102 may be formed about, molded to, or otherwise sealed to the PCD stationary phase 118.

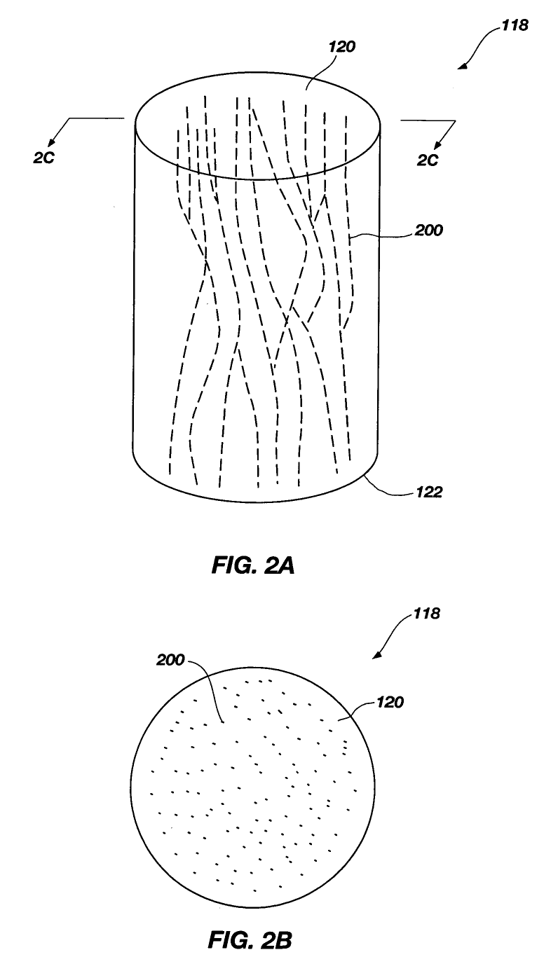

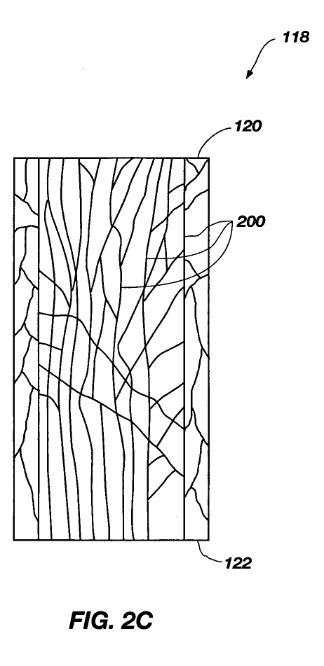

FIGS. 2A-2C are perspective, top plan, and cross-sectional views, respectively, of the PCD stationary phase 118 shown in FIGS. 1A and 1B. The PCD stationary phase 118 comprises a mass of sintered diamond grains including a network of at least partially interconnected pores that form a plurality of passageways 200 (shown in phantom in FIG. 2A). The passageways 200 extend between the inlet 120 and the outlet 122 and are structured to enable fluid (e.g., a liquid or gas) to flow through the inlet 120 and out of the outlet 122 (or vice versa). The PCD stationary phase 118 provides a highly chemically-resistant stationary phase that may exhibit a relatively high internal surface area and flow rate for a given pressure compared to a mass of unsintered diamond particles. Further, the PCD stationary phase 118 may be easier to handle and be capable of withstanding higher pressures than a mass of unsintered diamond particles.

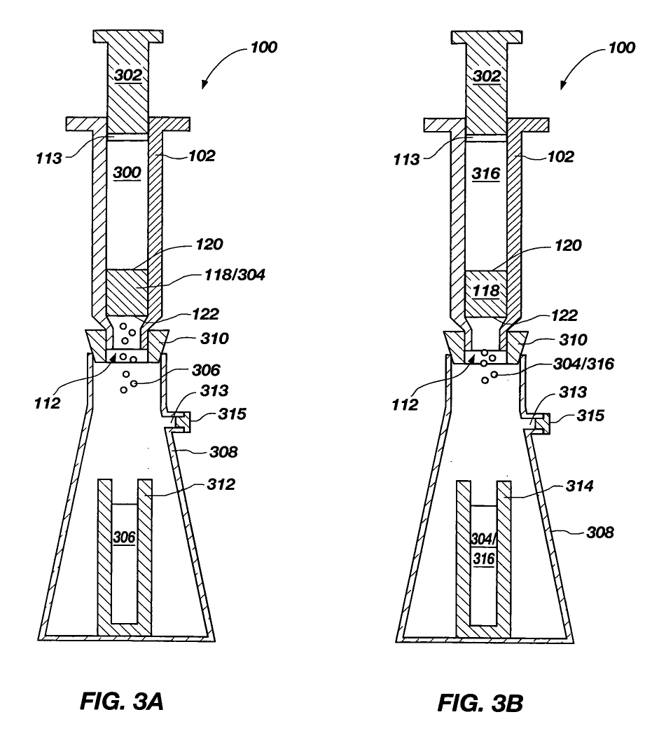

The operation of the SPE cartridge 100 is best understood with reference to FIGS. 3A and 3B. Referring to FIG. 3A, a liquid sample 300 (e.g., an aqueous solution or an organic solution) may be disposed within the interior space 113 of the housing 102. The liquid sample 300 may include a matrix with one or more types of analytes dissolved therein and/or dispersed therethrough. The liquid sample 300 may be urged through the PCD stationary phase 118 using, for example, a plunger 302 that is axially displaced within the interior space 113 of the housing 102, a syringe (not shown), or another pressure-generating device configured to generate pressure capable of urging the liquid sample 300 (e.g., positive pressure). In other embodiments of the present invention, compressed air or other gas flowed through a pressurized air line (not shown) may be used to force the liquid sample 300 through the PCD stationary phase 118. As the liquid sample 300 passes through the PCD stationary phase 118, at least one constituent 304 (e.g., at least one type of analyte) of the liquid sample 300 may selectively bind to the PCD stationary phase 118 within the passageways 200 (FIGS. 2A-2C). In certain embodiments of the present invention, the PCD stationary phase 118 is formulated to preferentially bind to a plurality of different constituents (e.g., a plurality of different types of analytes) of the liquid sample 300. A matrix 306 of the liquid sample 300 does not bind to the PCD stationary phase 118 and exits through the outlet 122 of the PCD stationary phase 118 and the housing outlet 112 of the housing 102. The matrix 306 may be a solvent in which the at least one constituent is dissolved in or another liquid that acts as a carrier medium for the at least constituent. The matrix 306 may be repeatedly urged through the PCD stationary phase 118, if desired.

Still referring to FIG. 3A, the SPE cartridge 100 may be connected to a container 308 (e.g., a suction flask) via, for example, a gasket 310. The container 308 may hold a collection tube 312 that collects the matrix 306 that flows through the PCD stationary phase 118 and out of the housing outlet 112. The container 308 may further include a vacuum port 313 (shown with a plug 315 inserted therein) configured to be operably connected to a vacuum pump (not shown). In one mode of operation according to an embodiment of the present invention, the SPE cartridge 100 may be used to purify the liquid sample 300. In such an embodiment, the matrix 306, which may include many different components, may be further analyzed using chromatography, mass spectrometry, or another suitable technique.

Referring to FIG. 3B, in a second mode of operation according to another embodiment of the present invention, the SPE cartridge 100 may be employed to capture one or more selected analytes. In such an embodiment, the collection tube 312 may be removed and replaced with a cleaned or different collection tube 314. The at least one constituent 304 (i.e., at least one type of analyte) captured by the PCD stationary phase 118 may be eluted by passing an eluting solution 316 disposed within the interior space 113 of the housing 102 through the PCD stationary phase 118 using the plunger 302. The eluting solution 316 may exhibit a selectivity to preferentially remove or dissolve the at least one constituent 304 (or multiple different analytes) bound to the internal surfaces of the diamond grains defining the passageways 200 (FIGS. 2A-2C). The eluting solution 316 and the at least one constituent 304 dissolved therein or dispersed therethrough collected in the collection tube 314 may be analyzed using, for example, chromatography, mass spectrometry, or another suitable analytical technique.

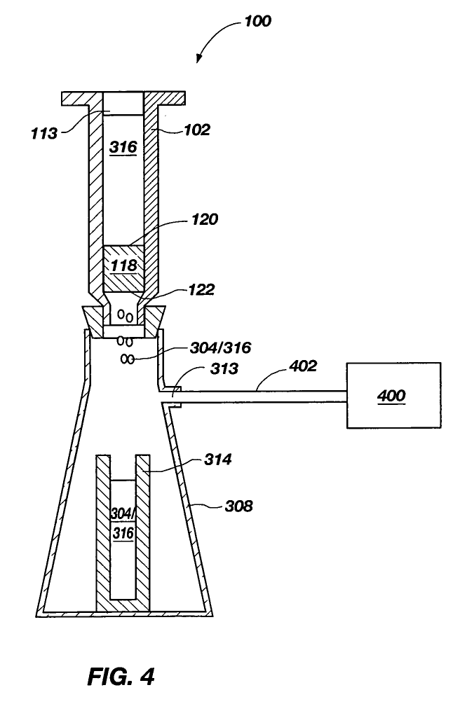

Referring to FIG. 4, in other embodiments of the prevent invention, the liquid sample 300 and the eluting solution 316 may be urged through the PCD stationary phase 118 using a vacuum pump (i.e., negative pressure). For example, in another embodiment of the present invention illustrated in FIG. 4, a vacuum pump 400 may be operably connected to the vacuum port 313 of the container 308 via a fluid line 402 that is configured to draw, for example, the eluting solution 316 (or the liquid sample 300) through the PCD stationary phase 118.

In yet another embodiment of the present invention, the liquid sample 300 and/or the eluting solution 316 may be separately urged through the PCD stationary phase 118 by centrifuging the SPE cartridge 100 containing the liquid sample 300 or the eluting solution 316. For example, a number of the SPE cartridges 100 may be simultaneously rotated in a centrifuge to elute at least one type of analyte from a stationary phase.

In certain embodiments of the present invention, multiple SPE cartridges 100 may be used in conjunction with a vacuum manifold apparatus that may be conventional in construction. Such a vacuum manifold apparatus may include provisions for simultaneously processing multiple SPE cartridges 100. In other embodiments of the present invention, an SPE apparatus may be configured as a well plate including a plurality of wells, with each well configured similarly to the SPE cartridge 100. For example, each well may be defined by a housing similarly configured to the housing 102 shown in FIG. 1 that are each integrally formed with each other. It is also contemplated that in other embodiments of the present invention, the SPE cartridge 100 may be integrated into a chromatography system or other analytical instrument. For example, the liquid sample 113 may be purified in situ by the SPE cartridge 100 prior to being analyzed by, for example, a liquid chromatography unit of a liquid chromatography system.

Turning again to FIGS. 2A-2C, in one embodiment of the present invention, interior surfaces of the diamond grains that define the passageways 200 are capable of capturing certain types of chemicals. For example, the interior surfaces of the diamond grains may include hydroxyl groups bonded thereto capable of selectively bonding with certain hydrophilic chemical liquid samples flowed through the passageways 200 of the PCD stationary phase 118. U.S. Patent Application Publication US2004/0118762 to Xu et al., the disclosure of which is incorporated herein in its entirety by this reference, discloses methods for functionalizing diamond surfaces that are chemically stable in highly basic solutions.

In yet another embodiment of the present invention, a selected stationary phase (e.g., a liquid, an adsorbent, or another substance) may at least partially coat or cover interior diamond surfaces of the PCD stationary phase 118 that define the passageways 200. Examples of suitable stationary phases that may be disposed within the passageways 200 are polymeric stationary phases, porous graphitized carbon, C₆ hydrocarbons, C₈ hydrocarbons, C₁₂ hydrocarbon, C₁₈ hydrocarbons, cyclohexyl, phenyl, amino, carboxyl, sulfonic acid, quarternary amine, or another suitable stationary phase. Accordingly, as used herein, the phrase “stationary phase” may encompass a mass of sintered diamond grains or a mass of un-sintered diamond particles in which interior surfaces of the diamond grains or diamond particles may be functionalized. As used herein, the phrase “stationary phase” may also encompass a mass of sintered diamond grains or a mass of un-sintered diamond particles including a stationary phase disposed therein. In yet a further embodiment of the present invention, interior surfaces of the diamond grains that define the passageways 200 may be etched to be roughened and increase the surface area thereof, which enables higher loading of the PCD stationary phase 118 per unit volume compared to when the diamond grains are not etched.

The PCD stationary phase 118 shown in FIGS. 1A and 2A-2C may be formed by sintering diamond particles having a selected particles size distribution. For example, prior to sintering, the diamond particles may have an average particle size from about 1 nm to about 1000 μm, and more typically from about 2 μm to about 150 μm. In one embodiment of the present invention, the PCD stationary phase 118 is formed by sintering diamond particles using an ultra-high pressure, ultra-high temperature (“HPHT”) process. The sintering may be effected in an ultra-high pressure press at process conditions of, for example, a pressure of at least about 20 kilobar (e.g., about 40 kilobar to about 70 kilobar) and a temperature of at least about 500° C. (e.g., about 1000° C. to about 1600° C.) for a time sufficient to consolidate and form a coherent mass of bonded diamond grains. The size of the passageways 200 formed in the PCD stationary phase 118 may be controlled, predominately, by proper selection of the diamond particle size and sintering pressure. For example, each passageway 200 may exhibit a lateral dimension (e.g., a diameter) of about 10 angstroms to about 1000 μm.

The interior surfaces of the diamond grains that define the passageways 200 may be etched to be roughened and increase the surface area thereof by exposing the interior surfaces to a suitable etchant. For example, suitable etchants capable of etching diamond include, but are not limited to, plasma etching (e.g., plasma activated hydrogen, inductively coupled plasma oxygen etching, or a SF6/O₂ plasma mixtures), oxygen etching (e.g., molecular oxygen, water vapor, oxygen plasma, or molten KNO₃) and molten rare earth metal(s) (e.g., lanthanum, cerium, or alloys thereof). However, in another embodiment of the present invention, the diamond particles may be exposed to one or more of the aforementioned etchants and, subsequently, subjected to a HPHT sintering process to form the PCD stationary phase 118. In such an embodiment, the interior surfaces of the diamond grains that define the passageways 200 may retain an etched surface despite being subjected to the HPHT processing.

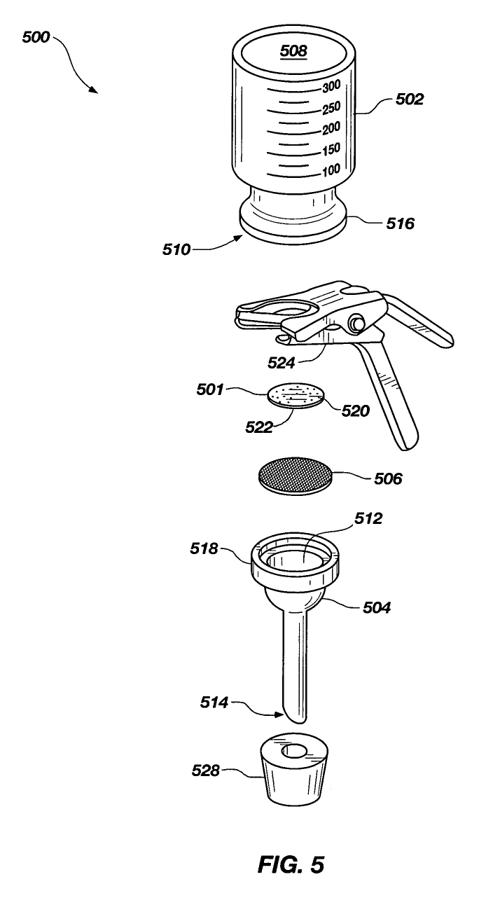

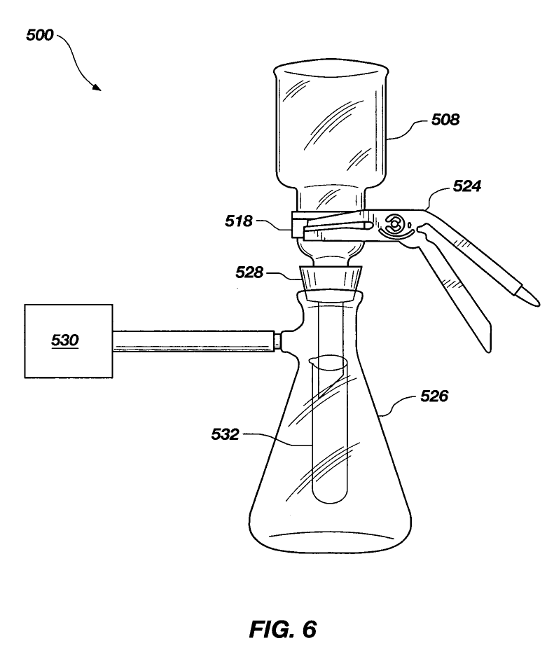

Further embodiments of the present invention are directed to an SPE apparatus that employs a PCD stationary phase disk. A stationary phase disk may be utilized for relatively large volume liquid samples and/or relatively high flow rates compared to the PCD stationary phase 118 shown in FIG. 1A that is configured as an elongated body. FIGS. 5 and 6 are a partial, exploded perspective view and a side elevation view, respectively, of an SPE apparatus 500 that employs a PCD stationary phase disk 501 according to yet another embodiment of the present invention. Referring to FIG. 5, the SPE apparatus 500 includes a funnel 502, a base 504, and the PCD stationary phase disk 501 received within the base 504. In certain embodiments of the present invention, a disk support 506 in the form of a metal screen or other porous medium may be provided on which the PCD stationary phase disk 501 may be supported within the base 504. The funnel 502 includes an inlet 508 and an outlet 510 and the base 504 also includes an inlet 512 and an outlet 514. The outlet 510 of the funnel 502 may be located proximate to a flange 516 (as illustrated), and the inlet 512 of the base 504 may be located proximate to a flange 518. The PCD stationary phase disk 501 comprises a mass of sintered diamond grains defining passageways (not shown) extending between an inlet face 520 and an opposing outlet face 522 thereof. The PCD stationary phase disk 501 may be made from the same or similar materials and may be manufactured according to the same or similar processes as the PCD stationary phase 118 shown in FIGS. 1 and 2A-2C.

FIG. 6 shows the SPE apparatus 500 assembled. The SPE apparatus 500 further includes a holder 524 (e.g., a spring clamp or other suitable clamp) configured to clamp and hold the flange 516 of the funnel 502 and the flange 518 of the base 504 so that the outlet 510 of the funnel 502 is in fluid communication with the PCD stationary phase disk 501 disposed within the base 504, the outlet 514 of the base 504, and a low pressure chamber defined by a container 526 (e.g., a suction flask). A gasket 528 or other seal element may be used to generally seal the low pressure chamber of the flask 526 from the ambient environment. A vacuum pump 530 may be operably coupled to the low pressure chamber of the container 526. If desired, a collection tube 532 may be contained within low pressure chamber 526 to collect fluids, such as a liquid sample and/or an eluting solution.

The operation of the SPE apparatus 500 is similar to the operation of the SPE cartridge 100. For example, a liquid sample may be poured into the funnel 502 and drawn through the PCD stationary phase disk 501 using the vacuum pump 530 so that at least one constituent (e.g., at least one type of analyte) of the liquid solution may be captured by the PCD stationary phase disk 501. A matrix of the liquid sample may be collected in the collection tube 532. If desired, the collection tube 532 may be cleaned or replaced, and then the at least one constituent captured by the PCD stationary phase disk 501 may be eluted by drawing an eluting solution poured into the funnel 502 through the PCD stationary phase disk 501. The eluting solution and the eluted at least one constituent may also be collected in the collection tube 532 and further analyzed using a suitable analytical technique.

The stationary phases of the SPE apparatuses 100 and 500 are described above as being a mass of sintered diamond grains. However, in other embodiments of the present invention, the stationary phase may be in form of a mass of un-sintered diamond particles with exterior surfaces of the diamond particles being etched in accordance with the aforementioned etching techniques.

Although the present invention has been disclosed and described by way of some embodiments, it is apparent to those skilled in the art that several modifications to the described embodiments, as well as other embodiments of the present invention are possible without departing from the spirit and scope of the present invention. Additionally, the words “including,” “having,” and variants thereof (e.g., “includes” and “has”) as used herein, including the claims, shall have the same meaning as the word “comprising” and variants thereof (e.g., “comprise” and “comprises”) and mean “including, but not limited to.”

1. A solid phase extraction (“SPE”) cartridge, comprising:
a housing comprising:
a proximal first end including a housing inlet exhibiting a first lateral dimension;
a distal second end including a housing outlet exhibiting a second lateral dimension less than that of the first lateral dimension; and
an interior space extending between the housing inlet and the housing outlet; and
an SPE stationary phase positioned within the interior space and including an inlet and an outlet, the SPE stationary phase comprising a mass of sintered diamond grains including a plurality of passageways extending therethrough between the inlet and the outlet.

2. The SPE cartridge of claim 1 wherein the mass of sintered diamond grains of the SPE stationary phase comprises interior diamond grain surfaces defining the passageways, at least some of the interior diamond grains surfaces being functionalized.

3. The SPE cartridge of claim 1 wherein the mass of sintered diamond grains of the SPE stationary phase comprises interior diamond grain surfaces defining the passageways, at least some of the interior diamond grains surfaces being at least partially coated with a selected stationary phase.

4. The SPE cartridge of claim 1 wherein the mass of sintered diamond grains of the SPE stationary phase comprises interior diamond grain surfaces defining the passageways, at least some of the interior diamond grains surfaces being etched.

5. The SPE cartridge of claim 1, further comprising:
a seal member extending peripherally about the SPE stationary phase and sealingly engaging the housing.

6. The SPE cartridge of claim 1 wherein the housing is configured to be operably coupled to a pressure-generating device operable to apply a pressure sufficient to force a liquid sample disposed within the interior space of the housing adjacent to the SPE stationary phase through the SPE stationary phase and out of the housing outlet.

7. The SPE cartridge of claim 6 wherein the pressure-generating device comprises a syringe or a plunger.

8. The SPE cartridge of claim 1 wherein the housing is configured to be operably coupled to a vacuum pump operable to draw a liquid sample disposed within the interior space of the housing through the SPE stationary phase and out of the housing outlet.

9. The SPE cartridge of claim 1, further comprising:
a filter positioned within the interior space such that a liquid sample passes therethrough and through the SPE stationary phase.

10. A solid phase extraction apparatus (“SPE”), comprising:
an SPE stationary phase disk including an inlet face and an opposing outlet face, the SPE stationary phase disk comprising a mass of sintered diamond grains including a plurality of passageways extending therethrough between the inlet face and the outlet face;
a holder configured to hold at least the SPE stationary phase disk so that a fluid can pass through the SPE stationary phase disk; and
a container configured to be in fluid communication with the outlet face of the SPE stationary phase disk.

11. The SPE apparatus of claim 10 wherein the mass of sintered diamond grains of the SPE stationary phase disk comprises interior diamond grain surfaces defining the passageways, at least some of the interior diamond grains surfaces being functionalized.

12. The SPE apparatus of claim 10 wherein the mass of sintered diamond grains of the SPE stationary phase disk comprises interior diamond grain surfaces defining the passageways, at least some of the interior diamond grains surfaces being at least partially coated with a selected stationary phase.

13. The SPE apparatus of claim 10 wherein the mass of sintered diamond grains of the SPE stationary phase disk comprises interior diamond grain surfaces defining the passageways, at least some of the interior diamond grains surfaces being etched.

14. The SPE apparatus of claim 10 wherein the container comprises a vacuum flask.

15. The SPE apparatus of claim 10:
further comprising a funnel including an outlet; and
wherein the holder comprises a clamp configured to hold the SPE stationary phase disk and the funnel so that the inlet face of the SPE stationary phase disk is in fluid communication with the outlet of the funnel.

16. The SPE apparatus of claim 15 wherein the clamp is further configured to hold the container.

17. A method, comprising:
flowing a liquid sample through a stationary phase comprising sintered diamond grains; and
capturing at least a portion of at least one constituent of the liquid sample in the stationary phase as the liquid sample flows through the stationary phase.

18. The method of claim 17 wherein flowing a liquid sample through a stationary phase comprising sintered diamond grains comprises:
applying pressure or a vacuum to urge the liquid sample through the stationary phase.

19. The method of claim 17 wherein flowing a liquid sample through a stationary phase comprising sintered diamond grains comprises:
flowing the liquid sample through a plurality of passageways defined by interior diamond grain surfaces of the sintered diamond grains, at least some of the interior diamond grains surfaces being etched.

20. The method of claim 17 wherein the at least one constituent comprises at least one type of analyte.

21. The method of claim 20, further comprising:
eluting the at least one type of analyte from the stationary phase.

22. The method of claim 21, further comprising:
collecting the at least one type of analyte eluted from the stationary phase; and
analyzing the collected at least one type of analyte.

23. The method of claim 21 wherein eluting the at least one type of analyte from the stationary phase comprises:
passing a solvent exhibiting an affinity for the at least one type of analyte through the stationary phase.

24. The method of claim 17 wherein:
the stationary phase comprises a plurality of passageways formed by etched surfaces of the sintered diamond grains; and
flowing a liquid sample through a stationary phase comprising sintered diamond grains comprises flowing the liquid sample through the passageways.

25. The method of claim 17 wherein:
capturing at least a portion of at least one constituent of the liquid sample in the stationary phase as the liquid sample flows through the stationary phase comprises capturing at least a portion of a plurality of different types of analytes of the liquid sample in the stationary phase as the liquid sample flows through the stationary phase; and
eluting the at least one type of analyte from the stationary phase comprises eluting each of the different types of analytes from the stationary phase.

26. A solid phase extraction (“SPE”) cartridge, comprising:
a housing comprising a proximal first end including a housing inlet, a distal second end including a housing outlet, and an interior space extending between the housing inlet and the housing outlet; and
an SPE stationary phase positioned within the interior space, the SPE stationary phase comprising a mass of diamond particles including surfaces, at least some of the surfaces of the diamond particles being etched.

27. A method, comprising:
flowing a liquid sample through a stationary phase comprising diamond particles having etched surfaces; and
capturing at least a portion of at least one constituent of the liquid sample in the stationary phase as the liquid sample flows through the stationary phase.
